(19) United States
(12) Patent Application Publication
(10) Pub. No.: US 2025/0350746 A1
(43) Pub. Date: Nov. 13, 2025

(54) DIRECTIONAL BLOCK BOUNDARY SMOOTHING

(71) Applicant: Nokia Technologies Oy, Espoo (FI)

(72) Inventors: Krit PANUSOPONE, San Diego, CA (US); Seungwook HONG, San Diego, CA (US); Limin WANG, San Diego, CA (US); Jani LAINEMA, Tampere (FI)

(21) Appl. No.: 19/204,683

(22) Filed: May 12, 2025

Related U.S. Application Data
(60) Provisional application No. 63/645,374, filed on May 10, 2024.

(51) Int. Cl. H04N 19/176; G06T 5/70; G06V 10/60; H04N 19/105; H04N 19/159

(52) U.S. Cl. CPC H04N 19/176; G06T 5/70; G06V 10/60; H04N 19/105; H04N 19/159

(57) ABSTRACT

An apparatus configured to: analyze a reference area of a prediction block to determine at least one dominant direction of the reference area of the prediction block; and adjust a pixel value of a boundary pixel of the prediction block along the at least one dominant direction of the reference area of the prediction block.

### TECHNICAL FIELD

The examples and non-limiting embodiments relate generally to directional block boundary smoothing.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 shows a DIMD template consisting of pixels outside of a prediction block.

FIG. 2 shows a DIMD template consisting of pixels inside a prediction block.

FIG. 3 shows an example of a TIMD template.

FIG. 4 shows a location of a reconstructed pixel R(x′, y′) for prediction pixel P(x, y) for an example dominant direction.

FIG. 5 shows a location of a reconstructed pixel R(x′, y′) for prediction pixel P(x, y) for an example dominant direction, with 180 degrees added to an angle defined by the example dominant direction.

FIG. 6 is a block diagram illustrating a system in accordance with an example.

FIG. 7 is an example apparatus configured to implement the examples described herein.

FIG. 8 shows a representation of an example of non-volatile memory media used to store instructions that implement the examples described herein.

FIG. 9 shows an encoder according to an embodiment.

FIG. 10 shows a decoder according to an embodiment.

FIG. 11 is an example method, based on the examples described herein.

### DETAILED DESCRIPTION OF EXAMPLE EMBODIMENTS

Versatile Video Coding (VVC) is a new international video coding standard and Enhanced Compression Model (ECM) built on top of VVC is potentially a future video coding standard that is currently under the development sponsored by JVET. Both VVC and ECM are block-based video coding standards, where an input picture is divided into CTUs, and each CTU may be further split into CUs. A CU (or block) is coded in either inter coding mode or intra coding mode. If the block is in inter coding mode, encoder searches for a temporal prediction block in reference picture(s), and signals decoder how to find the same prediction block in reference picture(s) at the decoder end. If the block is in intra coding mode, encoder constructs a spatial prediction block from the current picture, and signal decoder how to form the same spatial prediction block from the current picture at the decoder end. If the block is in inter coding mode, encoder constructs an associated temporal prediction block in the reference picture, and signal decoder how to form the same temporal prediction block from the reference picture at the decoder end.

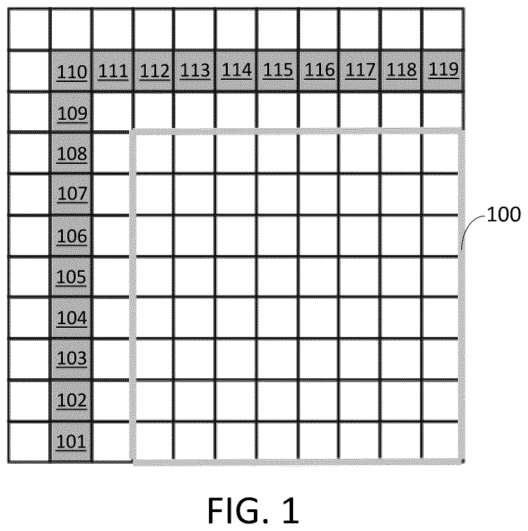

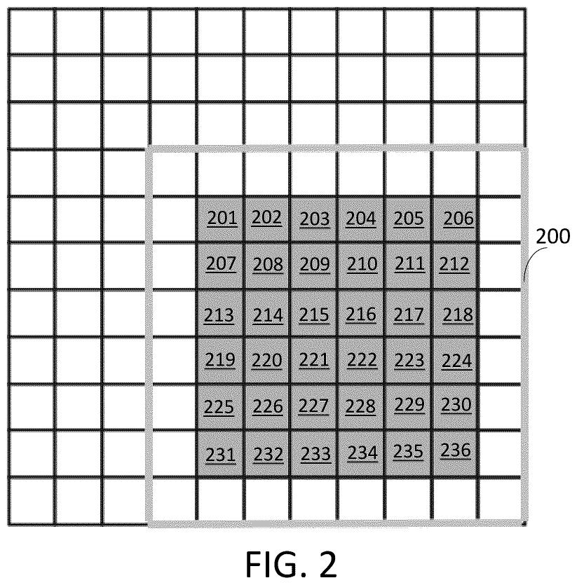

DIMD is an intra tool used by ECM to derive intra prediction mode of a block by analyzing pixels in template associated with the block. Specifically, a directional gradient consisting of direction and strength is computed for certain pixels in the template as shown in FIG. 1 and FIG. 2. Aggregated gradient for each direction from pixels in the template is then used to build a histogram of gradients. The histogram determines one or more mode(s) based on histogram bin values to be used in intra prediction.

FIG. 1 shows a DIMD template consisting of pixels outside of a prediction block 100, namely pixels 101, 102, 103, 104, 105, 106, 107, 108, 109, 110, 111, 112, 113, 114, 115, 116, 117, 118, and 119. FIG. 2 shows DIMD template consisting of pixels inside a prediction block 200, namely pixels 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, and 236.

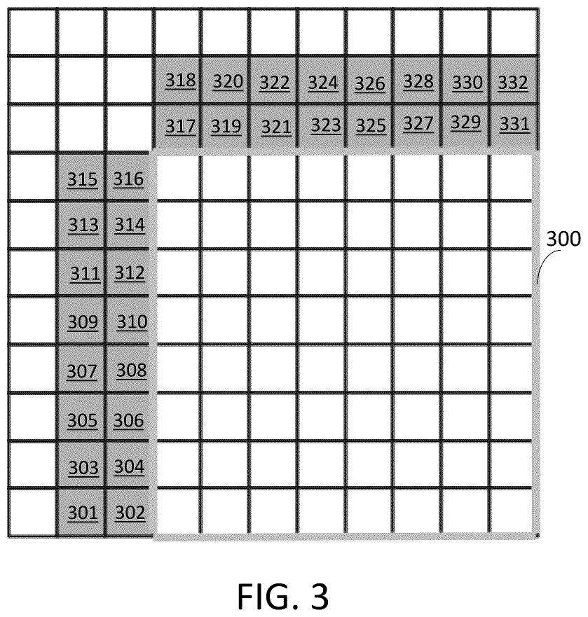

TIMD is also an intra tool used by ECM to derive an intra prediction mode of a block by searching for direction that provides the lowest matching cost between prediction (based on the test direction) and reconstruction pixels of the template. An example of TIMD template is shown in FIG. 3. The TIMD template shown in FIG. 3 consists of pixels outside the prediction block 300, namely pixels 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, and 332.

In VVC and ECM, PDPC is used to smooth boundary of prediction block. PDPC looks at reconstructed pixels along the top and left boundaries of the prediction block and computes a weighted difference between the reconstructed pixels and boundary pixels in the prediction block. Boundary pixels are pixels close to the top and left boundaries of the prediction block. The weighted difference is then added to the pixel value to determine a smoothed prediction block.

In VVC and ECM, some intra and inter coding tools (such as intra TMP, MIP, inter block that doesn't meet OBMC enabling constraints) don't use any block boundary smoothing for their prediction block. This is because there is no explicit direction associated with the modes used to generate the prediction block.

Described herein is a method to smooth a boundary of a prediction block along one or more dominant direction(s) of a pattern in the prediction block or a pattern associated with the prediction block. The one or more dominant directions can be determined by analyzing pixels in the prediction block, or a template of pixels (for example reference pixels) inside the prediction block, or a template of reconstructed pixels around the prediction block.

Two main steps are used to smooth boundary of prediction block: analysis of the reference area to determine one or more dominant direction(s) and application of smoothing process along one or more dominant direction(s).

Reference area is an area associated with a prediction block that is available at decoder. It can include pixels in the prediction block (FIG. 2) and/or reconstructed pixels in a template around the prediction block (FIG. 1). Pixels in the reference area are analyzed by statistical method such as gradient analysis used by DIMD or by searching method such as template matching used by TIMD. Output of the analysis is one or more dominant direction(s) that determine smoothing direction(s).

The smoothing process adjusts pixel value of boundary pixels to make them closer to those in the neighboring reconstructed blocks. There are many possible ways to control the impact of smoothing process such as distance based, i.e. greater for pixels close to the boundary compared to pixels further away.

Impact of smoothing process can also be controlled based on G or gradient strength of the dominant direction in the reference area. In one embodiment, the impact of smoothing process is less when G is less than a threshold. The threshold can be a fixed value or an adaptive value such as a factor of an aggregated value of gradient strengths from all directions.

An example of directional smoothing process can be described using the following equation.

$$S ( x , y ) = P ( x , y ) + W ( x , y ) \cdot ( R ( {x}^{′} , {y}^{′} ) - P ( x , y ) )$$

In the above equation, S(x, y) is an intensity of the smoothed pixel at (x, y), P(x, y) is an intensity of predicted pixel at (x, y), W(x, y) is a smoothing weight associated with S(x, y), and R(x′, y′) is an intensity of reconstructed pixel at (x′, y′) in the neighboring block corresponding to S(x, y).

Even though the above equation shows one W(x, y), the value of W(x, y) applied to R(x′, y′) may be the same as or different from the weight applied to P(x, y). Thus, the at least one smoothing weight W(x, y) may comprise a first smoothing weight applied to the at least one reference pixel (e.g. (x′, y′)) and a second smoothing weight applied to the boundary pixel (e.g. P(x, y)).

The notation P(x, y), S(x, y), and R(x′, y′) may also be used herein to denote pixels. For example, P(x, y) corresponds to a boundary pixel, S(x, y) corresponds to a boundary pixel, and R(x′, y′) corresponds to a reconstructed pixel or a reference pixel.

In a general case, one or more reconstructed pixel(s) in a neighboring block R(x′, y′), one or more predicted pixel(s) P(x, y), and one or more weight(s) W(x, y) may be involved in determining S(x, y).

Reconstructed pixel R(x′, y′) locates in a neighboring block. In the case that the neighboring block hasn't been coded, R(x′, y′) is determined by padding or estimating from other reconstructed pixels that have already been coded.

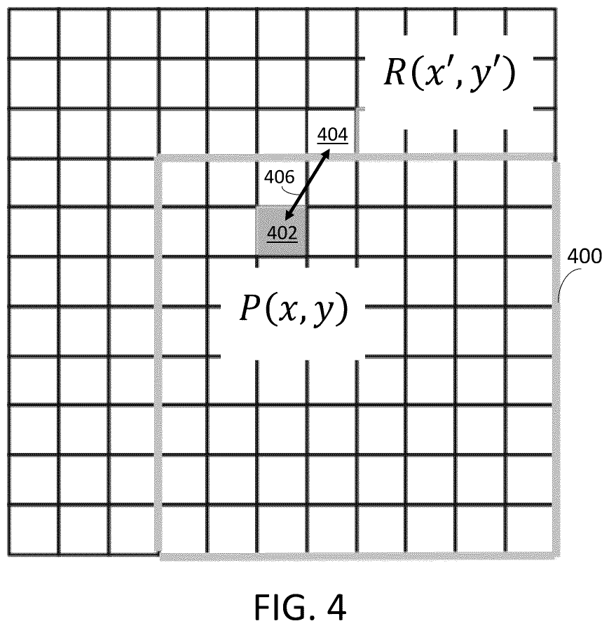

In directional smoothing, there are several ways to determine R(x′, y′) used to smooth predicted pixel P(x, y). Referring to FIG. 4, in one embodiment, R(x′, y′) 404 is determined based on an angular prediction mode; i.e., R(x′, y′) 404 is determined to be in a neighboring block adjacent to either the top boundary or the left boundary of the prediction block 400 projected to be along the dominant direction 406 from prediction pixel P(x, y) 402, as shown in FIG. 4. Thus, FIG. 4 shows a location of a reconstructed pixel R(x′, y′) 404 for prediction pixel P(x, y) 402 for an example dominant direction 406. In the example shown in FIG. 4, reference pixel or reconstructed pixel R(x′, y′) 404 is projected to be along the dominant direction from prediction pixel P(x, y) 402, and the neighboring block comprising reference pixel or reconstructed pixel R(x′, y′) 404 is projected to be along the dominant direction from prediction pixel P(x, y) 402.

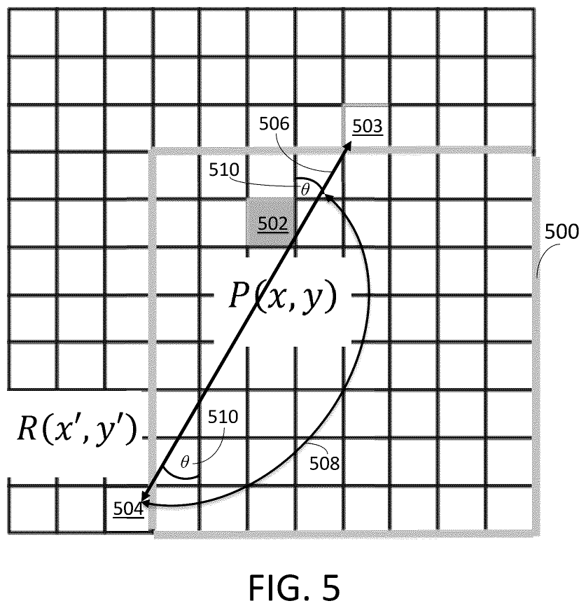

In another embodiment, referring to FIG. 5, R(x′, y′) 504 is determined based on PDPC; i.e., R(x′, y′) 504 is determined to be a pixel 504 in a neighboring block adjacent to the boundary of the prediction block 500 that is along the same direction as a pixel 503 projected to be along the dominant direction 506. In an embodiment, 180 degrees (where 180 degrees is denoted by item 508) is added to an angle θ (510) defined by the dominant direction 506 to pixel 503 from prediction pixel P(x, y) 502 to obtain R(x′, y′) 504, as shown in FIG. 5. The reference pixel R(x′, y′) 504 is along the same dominant direction 506 as pixel 503 is from prediction pixel P(x, y) 502, except that pixel 503 is in a block that neighbors the top boundary of prediction block 500, and reference pixel R(x′, y′) 504 is in a block that neighbors the left boundary of prediction block 500. Thus, FIG. 5 shows a location of a reconstructed pixel R(x′, y′) 504 for prediction pixel P(x, y) 502 for an example dominant direction 506, with 180 degrees (508) added to an angle θ (510) defined by dominant direction 506. The angle θ (510) is expressed in degrees. In the example shown in FIG. 5, R(x′, y′) 504 is an inverse of reference pixel 503, which reference pixel 503 is projected to be along the dominant direction 506 from prediction pixel P(x, y) 502. In the example shown in FIG. 5, reference pixel 503 is projected to be along the dominant direction from prediction pixel P(x, y) 502, and the neighboring block comprising reference pixel 503 is projected to be along the dominant direction from prediction pixel P(x, y) 502. Reference pixel 503 may be a reconstructed pixel.

In yet another embodiment, directional boundary smoothing is performed using multiple dominant directions. In this embodiment, smoothing process can be performed for each direction separately and final smoothed prediction block is computed by blending smoothed prediction block for each direction together. Blending weight for each direction can be set equally or set to different values according to external means.

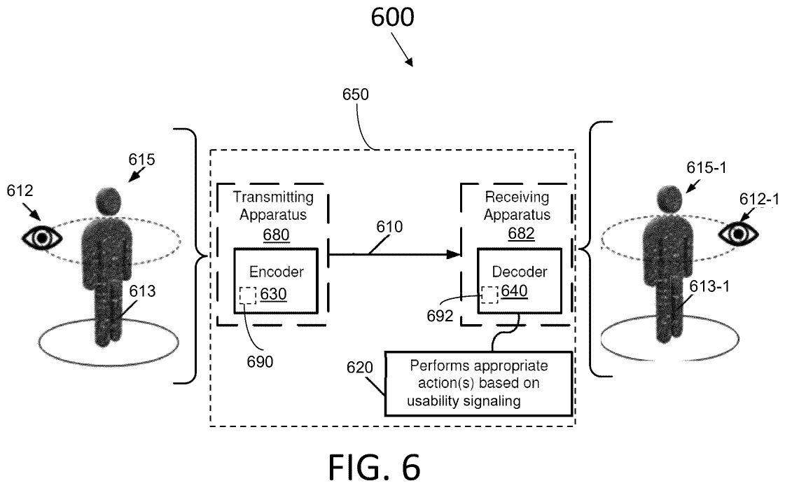

FIG. 6 is a block diagram illustrating a system 600 in accordance with several examples. In an example, the encoder 630 is used to encode an image or video from the scene 615, and the encoder 630 is implemented in a transmitting apparatus 680. The encoder 630 produces a bitstream 610 comprising signaling that is received by the receiving apparatus 682, which implements a decoder 640. The encoder 630 sends the bitstream 610 that comprises the herein described signaling. The decoder 640 forms the image or video for the scene 615-1, and the receiving apparatus 682 would present this to the user, e.g., via a smartphone, television, or projector among many other options.

In some examples, the transmitting apparatus 680 and the receiving apparatus 682 are at least partially within a common apparatus, and for example are located within a common housing 650. In other examples the transmitting apparatus 680 and the receiving apparatus 682 are at least partially not within a common apparatus and have at least partially different housings. Therefore in some examples, the encoder 630 and the decoder 640 are at least partially within a common apparatus, and for example are located within a common housing 650. For example the common apparatus comprising the encoder 630 and decoder 640 implements a codec. In other examples the encoder 630 and the decoder 640 are at least partially not within a common apparatus and have at least partially different housings, but when together still implement a codec.

In some examples, 3D media from the capture (e.g., volumetric capture) at a viewpoint 612 of the scene 615, which includes a person 613) is converted via projection to a series of 2D representations with occupancy, geometry, attributes and/or displacements. Additional atlas information is also included in the bitstream to enable inverse reconstruction. For decoding, the received bitstream 610 is separated into its components with atlas information; occupancy, geometry, displacement, and attribute 2D representations. A 3D reconstruction is performed to reconstruct the scene 615-1 created looking at the viewpoint 612-1 with a “reconstructed” person 613-1. The “-1” are used to indicate that these are reconstructions of the original. As indicated at 620, the decoder 640 performs an action or actions based on the received signaling.

Encoding 690 performs directional block boundary smoothing, based on the examples described herein. Decoding 692 performs directional block boundary smoothing, based on the examples described herein.

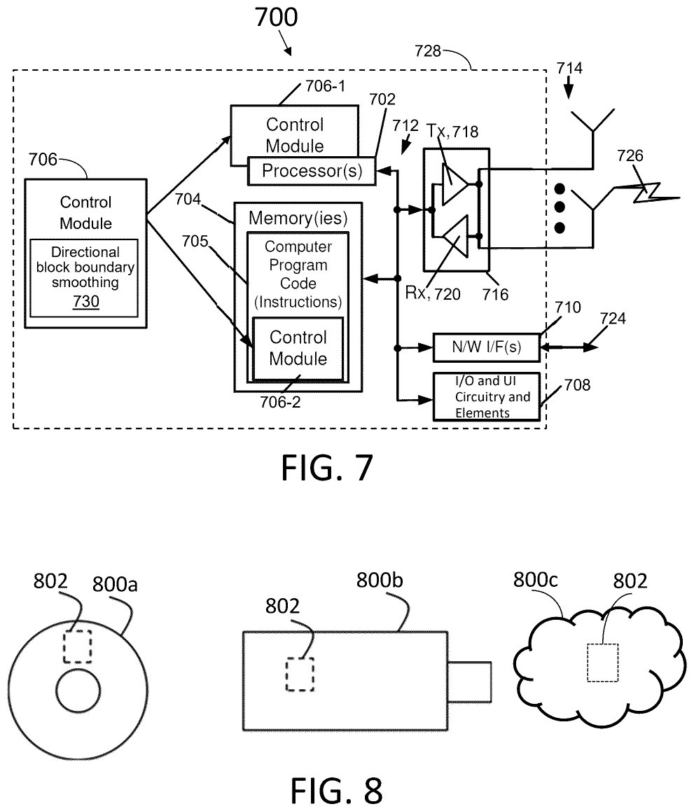

FIG. 7 is an example apparatus 700, which may be implemented in hardware, configured to implement the examples described herein. The apparatus 700 comprises at least one processor 702 (e.g., an FPGA and/or CPU and/or GPU), one or more memories 704 including computer program code 705, the computer program code 705 having instructions to carry out the methods described herein, wherein the at least one memory 704 and the computer program code 705 are configured to, with the at least one processor 702, cause the apparatus 700 to implement circuitry, a process, component, module, or function (implemented with control module 706) to implement the examples described herein.

Apparatus 700 may be a smartphone, personal digital device or assistant, smart television, laptop, pad, tablet, head-mounted display (HMD), or other user device or terminal device. The memory 704 may be a non-transitory memory, a transitory memory, a volatile memory (e.g. RAM), or a non-volatile memory (e.g., ROM).

Directional block boundary smoothing 730 implements the examples described herein related to directional block boundary smoothing.

The apparatus 700 includes a display and/or I/O interface 708, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 700 includes one or more communication e.g. network (N/W) interfaces (I/F(s)) 710. The communication I/F(s) 710 may be wired and/or wireless and communicate over the Internet/other network(s) via any communication technique including via one or more links 724. The communication I/F(s) 710 may comprise one or more transmitters or one or more receivers.

The transceiver 716 comprises one or more transmitters 718 and one or more receivers 720. The transceiver 716 and/or communication I/F(s) 710 may comprise standard well-known components such as an amplifier, filter, frequency-converter, (de)modulator, and encoder/decoder circuitries and one or more antennas, such as antennas 714 used for communication over wireless link 726.

The control module 706 of the apparatus 700 comprises one of or both parts 706-1 and/or 706-2, which may be implemented in a number of ways. The control module 706 may be implemented in hardware as control module 706-1, such as being implemented as part of the one or more processors 702. The control module 706-1 may be implemented also as an integrated circuit or through other hardware such as a programmable gate array. In another example, the control module 706 may be implemented as control module 706-2, which is implemented as computer program code (having corresponding instructions) 705 and is executed by the one or more processors 702. For instance, the one or more memories 704 store instructions that, when executed by the one or more processors 702, cause the apparatus 700 to perform one or more of the operations as described herein. Furthermore, the one or more processors 702, one or more memories 704, and example algorithms (e.g., as flowcharts and/or signaling diagrams), encoded as instructions, programs, or code, are means for causing performance of the operations described herein.

The apparatus 700 to implement the functionality of control 706 may correspond to any of the apparatuses depicted herein. Alternatively, apparatus 700 and its elements may not correspond to any of the other apparatuses depicted herein, as apparatus 700 may be part of a self-organizing/optimizing network (SON) node or other node, such as a node in a cloud.

The apparatus 700 may also be distributed throughout the network including within and between apparatus 700 and any network element (such as a base station and/or terminal device and/or user equipment).

Interface 712 enables data communication and signaling between the various items of apparatus 700, as shown in FIG. 7. For example, the interface 712 may be one or more buses such as address, data, or control buses, and may include any interconnection mechanism, such as a series of lines on a motherboard or integrated circuit, fiber optics or other optical communication equipment, and the like. Computer program code (e.g. instructions) 705, including control 706 may comprise object-oriented software configured to pass data or messages between objects within computer program code 705. Computer program code (e.g. instructions) 705, including control 706 may comprise procedural, functional, or scripting code. The apparatus 700 need not comprise each of the features mentioned, or may comprise other features as well. The various components of apparatus 700 may at least partially reside in a common housing 728, or a subset of the various components of apparatus 700 may at least partially be located in different housings, which different housings may include housing 728.

FIG. 8 shows a schematic representation of non-volatile memory media 800a (e.g. computer/compact disc (CD) or digital versatile disc (DVD)) and 800b (e.g. universal serial bus (USB) memory stick) and 800c (e.g. cloud storage for downloading instructions and/or parameters 802 or receiving emailed instructions and/or parameters 802) storing instructions and/or parameters 802 which when executed by a processor allows the processor to perform one or more of the operations of the methods described herein. Instructions and/or parameters 802 may represent or correspond to a non-transitory computer readable medium.

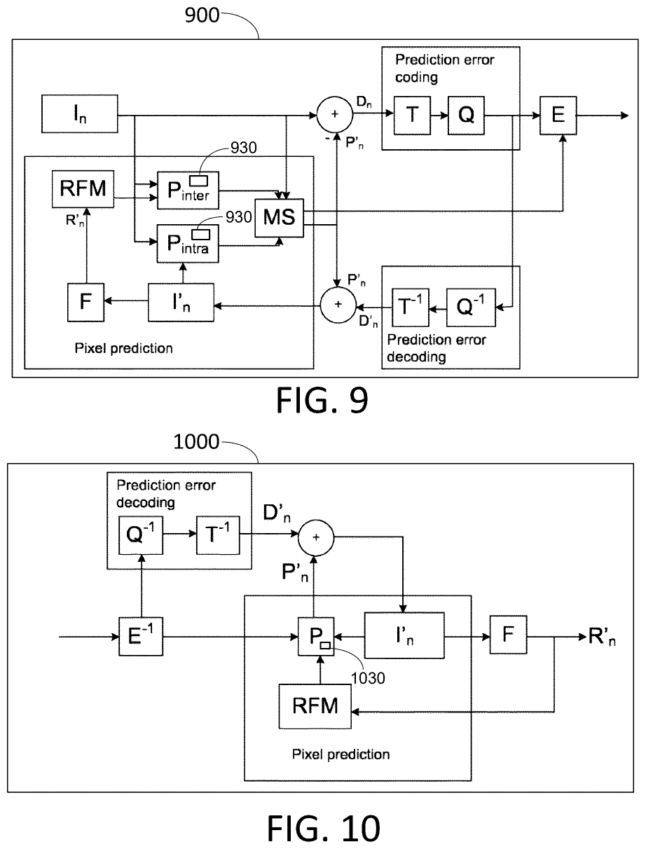

FIG. 9 shows an encoder 900 according to an embodiment. FIG. 9 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame memory (RFM), inter prediction (P^{inter}), intra prediction (p^{intra}), mode selection (MS) and filtering (F). Directional block boundary smoothing 930 within inter prediction (P^{inter}) and intra prediction (P^{intra}) implements the examples described herein related to directional block boundary smoothing.

FIG. 10 shows a decoder 1000 according to an embodiment. FIG. 10 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). Directional block boundary smoothing 1030 within prediction (either inter or intra) (P) implements the examples described herein related to directional block boundary smoothing.

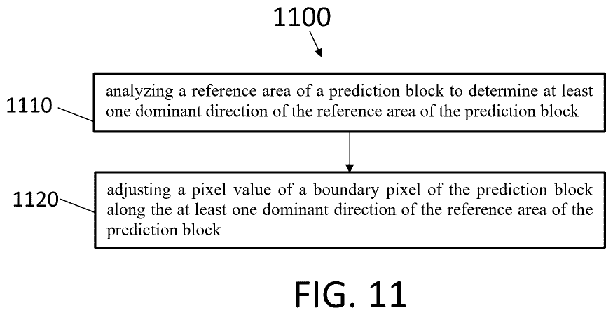

FIG. 11 is an example method 1100, based on the examples described herein. At 1110, the method includes analyzing a reference area of a prediction block to determine at least one dominant direction of the reference area of the prediction block. At 1120, the method includes adjusting a pixel value of a boundary pixel of the prediction block along the at least one dominant direction of the reference area of the prediction block. Method 1100 may be performed with encoder 630 using encoding 690, decoder 640 using decoding 692, apparatus 700 with directional block boundary smoothing 730, encoder 900 with directional block boundary smoothing 930, or decoder 1000 with directional block boundary smoothing 1030.

The following examples are provided and described herein.

Example 1. An apparatus including: at least one processor; and at least one memory storing instructions that, when executed by the at least one processor, cause the apparatus at least to: analyze a reference area of a prediction block to determine at least one dominant direction of the reference area of the prediction block; and adjust a pixel value of a boundary pixel of the prediction block along the at least one dominant direction of the reference area of the prediction block.

Example 2. The apparatus of example 1, wherein the reference area of the prediction block comprises at least one or more of: at least one pixel in the prediction block, or at least one reference pixel in a template around the prediction block.

Example 3. The apparatus of any of examples 1 to 2, wherein analyzing the reference area of the prediction block to determine the at least one dominant direction of the reference area of the prediction block is performed with a statistical method.

Example 4. The apparatus of example 3, wherein the statistical method comprises gradient analysis used with decoder side intra mode derivation.

Example 5. The apparatus of any of examples 1 to 4, wherein analyzing the reference area of the prediction block to determine the at least one dominant direction of the reference area of the prediction block is performed with a searching method.

Example 6. The apparatus of example 5, wherein the searching method comprises template matching used with template based intra mode derivation.

Example 7. The apparatus of any of examples 1 to 6, wherein the pixel value of the boundary pixel of the prediction block is adjusted along the at least one dominant direction of the reference area of the prediction block based on a gradient strength of the at least one dominant direction of the reference area.

Example 8. The apparatus of example 7, wherein the apparatus is caused to: determine the gradient strength of the at least one dominant direction of the reference area; and reduce an impact of the adjusting of the pixel value of the boundary pixel of the prediction block along the at least one dominant direction of the reference area of the prediction block, in response to the gradient strength of the at least one dominant direction of the reference area being less than a threshold.

Example 9. The apparatus of example 8, wherein the threshold comprises a fixed value.

Example 10. The apparatus of any of examples 8 to 9, wherein the apparatus is caused to: determine a first value of a first gradient strength of a first dominant direction of the reference area; determine a second value of a second gradient strength of a second dominant direction of the reference area; determine the threshold to be a factor of an aggregate of at least: the first value of the first gradient strength of the first dominant direction of the reference area, and the second value of the gradient strength of the second dominant direction of the reference area.

Example 11. The apparatus of any of examples 1 to 10, wherein the apparatus is caused to determine a smoothed intensity of the boundary pixel of the prediction block based on at least one or more of: at least one predicted pixel of the prediction block, or at least one prediction intensity of the boundary pixel of the prediction block, or at least one smoothing weight, or at least one reference pixel in a neighboring block that neighbors the prediction block, or at least one reference intensity of the respective at least one reference pixel in the neighboring block that neighbors the prediction block.

Example 12. The apparatus of example 11, wherein the at least one smoothing weight is based on a distance from the boundary pixel to a boundary of the prediction block.

Example 13. The apparatus of any of examples 11 to 12, wherein the at least one smoothing weight comprises a first smoothing weight applied to the at least one reference pixel and a second smoothing weight applied to the boundary pixel.

Example 14. The apparatus of any of examples 11 to 13, wherein: the at least one predicted pixel of the prediction block comprises at least one reconstructed pixel of the prediction block, or the at least one reference pixel in the neighboring block that neighbors the prediction block comprises at least one reconstructed pixel in the neighboring block that neighbors the prediction block.

Example 15. The apparatus of any of examples 1 to 14, wherein the apparatus is caused to: determine whether a neighboring block that neighbors the prediction block has been coded; determine at least one reference intensity of a respective at least one reference pixel in the neighboring block that neighbors the prediction block with padding or estimating at least one other reference intensity of at least one other reference pixel in a coded block that has been coded, in response to determining that the neighboring block that neighbors the prediction block has not been coded; and determine a smoothed intensity of the boundary pixel of the prediction block based on the at least one reference intensity of the respective at least one reference pixel in the neighboring block that neighbors the prediction block.

Example 16. The apparatus of any of examples 1 to 15, wherein the apparatus is caused to: determine a smoothed intensity of the boundary pixel of the prediction block to be a prediction intensity of the boundary pixel of the prediction block added to a smoothing weight multiplied with a difference between a reference intensity of a reference pixel in a neighboring block that neighbors the prediction block and the prediction intensity of the boundary pixel of the prediction block.

Example 17. The apparatus of any of examples 1 to 16, wherein the apparatus is caused to: determine a reference pixel in a neighboring block that neighbors a top boundary of the prediction block or a left boundary of the prediction block projected to be along the at least one dominant direction of the reference area of the prediction block from the boundary pixel of the prediction block; determine a reference intensity of at least a portion of the reference pixel in the neighboring block that neighbors the top boundary of the prediction block or the left boundary of the prediction block projected to be along the at least one dominant direction of the reference area of the prediction block from the boundary pixel of the prediction block; and determine a smoothed intensity of the boundary pixel of the prediction block based on the reference intensity of at least the portion of the reference pixel in the neighboring block that neighbors the top boundary of the prediction block or the left boundary of the prediction block projected to be along the at least one dominant direction of the reference area of the prediction block from the boundary pixel of the prediction block.

Example 18. The apparatus of any of examples 1 to 17, wherein the apparatus is caused to: determine a first reference pixel in a first neighboring block that neighbors a top boundary of the prediction block or a left boundary of the prediction block projected to be along the at least one dominant direction of the reference area of the prediction block from the boundary pixel of the prediction block; determine a second reference pixel in a second neighboring block that neighbors the top boundary of the prediction block or the left boundary of the prediction block projected to be along the at least one dominant direction of the reference area of the prediction block from the boundary pixel of the prediction block; wherein the boundary of the prediction block that the second neighboring block neighbors is different from the boundary of the prediction block that the first neighboring block neighbors; determine a reference intensity of the second reference pixel in the second neighboring block that neighbors the top boundary of the prediction block or the left boundary of the prediction block; and determine a smoothed intensity of the boundary pixel of the prediction block based on the reference intensity of the second reference pixel in the second neighboring block that neighbors the top boundary of the prediction block or the left boundary of the prediction block.

Example 19. The apparatus of any of examples 1 to 18, wherein the apparatus is caused to: determine multiple dominant directions of the reference area of the prediction block; wherein the boundary pixel of the prediction block is adjusted using the multiple dominant directions of the reference area of the prediction block.

Example 20. The apparatus of any of examples 1 to 19, wherein the apparatus is caused to: determine multiple respective dominant directions of the reference area of the prediction block; determine multiple smoothing results for the boundary pixel of the prediction block using the multiple respective dominant directions of the reference area of the prediction block; and determine a blended smoothing result for the boundary pixel of the prediction block with blending the multiple smoothing results for the boundary pixel of the prediction block determined using the multiple respective dominant directions of the reference area of the prediction block.

Example 21. The apparatus of any of examples 1 to 20, wherein the apparatus is caused to: determine multiple dominant directions of the reference area of the prediction block; determine multiple smoothing results for the boundary pixel of the prediction block obtained for the respective multiple dominant directions of the reference area of the prediction block; and determine a blended smoothing result for the boundary pixel of the prediction block based on a weighted combination of the multiple smoothing results for the boundary pixel determined for the multiple respective dominant directions of the reference area of the prediction block, using multiple respective weights for the multiple smoothing results.

Example 22. The apparatus of example 21, wherein the multiple respective weights for the multiple smoothing results for the boundary pixel of the prediction block determined for the multiple respective dominant directions of the reference area of the prediction block are equal.

Example 23. The apparatus of any of examples 21 to 22, wherein the apparatus is caused to: determine a first weight for a first smoothing result of the multiple smoothing results used to determine the blended smoothing result; and determine a second weight for a second smoothing result of the multiple smoothing results used to determine the blended smoothing result; wherein the first weight for the first smoothing result of the multiple smoothing results used to determine the blended smoothing result is determined to be different from the second weight for the second smoothing result of the multiple smoothing results used to determine the blended smoothing result.

Example 24. The apparatus of any of examples 1 to 23, wherein the apparatus is caused to: determine multiple dominant directions of the reference area of the prediction block; determine a ranking of the multiple dominant directions of the preference area of the prediction block, based on a respective amount of dominance determined for the respective multiple dominant directions of the reference area of the prediction block; wherein the boundary pixel of the prediction block is adjusted based on the ranking of the multiple dominant directions of the preference area of the prediction block.

Example 25. The apparatus of any of examples 1 to 24, wherein the pixel value of the boundary pixel of the prediction block is adjusted to be closer to a pixel value of a reference pixel in a reference block that neighbors the prediction block.

Example 26. The apparatus of any of examples 1 to 25, wherein a first difference between the pixel value of the boundary pixel of the prediction block and a pixel value of a reference pixel in a reference block that neighbors the prediction block obtained before the adjusting of the pixel value of the boundary pixel of the prediction block is greater than a second difference between the pixel value of the boundary pixel of the prediction block and the pixel value of the reference pixel in the reference block that neighbors the prediction block obtained after the adjusting of the pixel value of the boundary pixel of the prediction block.

Example 27. The apparatus of example 25 or example 26, wherein the reference pixel comprises a reconstructed pixel, and the reference block that neighbors the prediction block comprises a reconstructed reference block.

Example 28. The apparatus of any of examples 1 to 27, wherein: the boundary pixel is close to a left boundary of the prediction block; and the boundary pixel is close to a top boundary of the prediction block.

Example 29. The apparatus of any of examples 1 to 28, wherein: a number of zero, one, or more pixels between a left boundary of the prediction block and the boundary pixel is less than or equal to a left threshold value, wherein the left threshold value is used to determine whether the boundary pixel is close to the left boundary of the prediction block, or a number of zero, one, or more pixels between a top boundary of the prediction block and the boundary pixel is less than or equal to a top threshold value, wherein the top threshold value is used to determine whether the boundary pixel is close to the top boundary of the prediction block.

Example 30. The apparatus of any of examples 1 to 29, wherein the apparatus is caused to: receive a coding of an image, video, or scene; and reconstruct the image, video, or scene, based on the smoothing of the boundary of the prediction block along the at least one dominant direction of the reference area of the prediction block.

Example 31. A method including: analyzing a reference area of a prediction block to determine at least one dominant direction of the reference area of the prediction block; and adjusting a pixel value of a boundary pixel of the prediction block along the at least one dominant direction of the reference area of the prediction block.

Example 32. An apparatus including: means for analyzing a reference area of a prediction block to determine at least one dominant direction of the reference area of the prediction block; and means for adjusting a pixel value of a boundary pixel of the prediction block along the at least one dominant direction of the reference area of the prediction block.

Example 33. A computer readable medium including instructions stored thereon for performing at least the following: analyzing a reference area of a prediction block to determine at least one dominant direction of the reference area of the prediction block; and adjusting a pixel value of a boundary pixel of the prediction block along the at least one dominant direction of the reference area of the prediction block.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
ASIC application specific integrated circuit
CPU central processing unit
CTU coding tree unit
CU coding unit
DIMD decoder side intra mode derivation
ECM enhanced compression model
FPGA field programmable gate array
G gradient strength
GPU graphics processing unit
HMD head-mounted display
I/F interface
I/O input/output
JVET joint video experts team
MIP matrix-based intra prediction
N/W network
OBMC overlapped block motion compensation
PDPC position dependent intra prediction combination
RAM random access memory
RFM reference frame memory
ROM read only memory
SON self-organizing/optimizing network
TIMD template based intra mode derivation
TMP template matching prediction
UI user interface
USB universal serial bus
VVC versatile video coding

What is claimed is:

1. An apparatus comprising: at least one processor; and at least one memory storing instructions that, when executed by the at least one processor, cause the apparatus at least to: analyze a reference area of a prediction block to determine at least one dominant direction of the reference area of the prediction block; and adjust a pixel value of a boundary pixel of the prediction block along the at least one dominant direction of the reference area of the prediction block.

2. The apparatus of claim 1, wherein the reference area of the prediction block comprises at least one or more of: at least one pixel in the prediction block, or at least one reference pixel in a template around the prediction block.

3. The apparatus of claim 1, wherein analyzing the reference area of the prediction block to determine the at least one dominant direction of the reference area of the prediction block is performed with a statistical method.

4. The apparatus of claim 3, wherein the statistical method comprises gradient analysis used with decoder side intra mode derivation.

5. The apparatus of claim 1, wherein analyzing the reference area of the prediction block to determine the at least one dominant direction of the reference area of the prediction block is performed with a searching method.

6. The apparatus of claim 5, wherein the searching method comprises template matching used with template based intra mode derivation.

7. The apparatus of claim 1, wherein the pixel value of the boundary pixel of the prediction block is adjusted along the at least one dominant direction of the reference area of the prediction block based on a gradient strength of the at least one dominant direction of the reference area.

8. The apparatus of claim 7, wherein the apparatus is further caused to: determine the gradient strength of the at least one dominant direction of the reference area; and reduce an impact of the adjusting of the pixel value of the boundary pixel of the prediction block along the at least one dominant direction of the reference area of the prediction block, in response to the gradient strength of the at least one dominant direction of the reference area being less than a threshold.

9. The apparatus of claim 8, wherein the threshold comprises a fixed value.

10. The apparatus of claim 8, wherein the apparatus is further caused to: determine a first value of a first gradient strength of a first dominant direction of the reference area; determine a second value of a second gradient strength of a second dominant direction of the reference area; determine the threshold to be a factor of an aggregate of at least: the first value of the first gradient strength of the first dominant direction of the reference area, and the second value of the gradient strength of the second dominant direction of the reference area.

11. The apparatus of claim 1, wherein the apparatus is further caused to: determine a smoothed intensity of the boundary pixel of the prediction block based on at least one or more of: at least one predicted pixel of the prediction block, or at least one prediction intensity of the boundary pixel of the prediction block, or at least one smoothing weight, or at least one reference pixel in a neighboring block that neighbors the prediction block, or at least one reference intensity of the respective at least one reference pixel in the neighboring block that neighbors the prediction block.

12. The apparatus of claim 1, wherein the apparatus is further caused to: determine whether a neighboring block that neighbors the prediction block has been coded; determine at least one reference intensity of a respective at least one reference pixel in the neighboring block that neighbors the prediction block with padding or estimating at least one other reference intensity of at least one other reference pixel in a coded block that has been coded, in response to determining that the neighboring block that neighbors the prediction block has not been coded; and determine a smoothed intensity of the boundary pixel of the prediction block based on the at least one reference intensity of the respective at least one reference pixel in the neighboring block that neighbors the prediction block.

13. The apparatus of claim 1, wherein the apparatus is further caused to: determine a smoothed intensity of the boundary pixel of the prediction block to be a prediction intensity of the boundary pixel of the prediction block added to a smoothing weight multiplied with a difference between a reference intensity of a reference pixel in a neighboring block that neighbors the prediction block and the prediction intensity of the boundary pixel of the prediction block.

14. The apparatus of claim 1, wherein the apparatus is further caused to: determine a reference pixel in a neighboring block that neighbors a top boundary of the prediction block or a left boundary of the prediction block projected to be along the at least one dominant direction of the reference area of the prediction block from the boundary pixel of the prediction block; determine a reference intensity of at least a portion of the reference pixel in the neighboring block that neighbors the top boundary of the prediction block or the left boundary of the prediction block projected to be along the at least one dominant direction of the reference area of the prediction block from the boundary pixel of the prediction block; and determine a smoothed intensity of the boundary pixel of the prediction block based on the reference intensity of at least the portion of the reference pixel in the neighboring block that neighbors the top boundary of the prediction block or the left boundary of the prediction block projected to be along the at least one dominant direction of the reference area of the prediction block from the boundary pixel of the prediction block.

15. The apparatus of claim 1, wherein the apparatus is further caused to: determine a first reference pixel in a first neighboring block that neighbors a top boundary of the prediction block or a left boundary of the prediction block projected to be along the at least one dominant direction of the reference area of the prediction block from the boundary pixel of the prediction block; determine a second reference pixel in a second neighboring block that neighbors the top boundary of the prediction block or the left boundary of the prediction block projected to be along the at least one dominant direction of the reference area of the prediction block from the boundary pixel of the prediction block; wherein the boundary of the prediction block that the second neighboring block neighbors is different from the boundary of the prediction block that the first neighboring block neighbors; determine a reference intensity of the second reference pixel in the second neighboring block that neighbors the top boundary of the prediction block or the left boundary of the prediction block; and determine a smoothed intensity of the boundary pixel of the prediction block based on the reference intensity of the second reference pixel in the second neighboring block that neighbors the top boundary of the prediction block or the left boundary of the prediction block.

16. The apparatus of claim 1, wherein the apparatus is further caused to: determine multiple dominant directions of the reference area of the prediction block; wherein the boundary pixel of the prediction block is adjusted using the multiple dominant directions of the reference area of the prediction block.

17. The apparatus of claim 1, wherein the apparatus is further caused to: determine multiple respective dominant directions of the reference area of the prediction block; determine multiple smoothing results for the boundary pixel of the prediction block using the multiple respective dominant directions of the reference area of the prediction block; and determine a blended smoothing result for the boundary pixel of the prediction block with blending the multiple smoothing results for the boundary pixel of the prediction block determined using the multiple respective dominant directions of the reference area of the prediction block.

18. The apparatus of claim 1, wherein the apparatus is further caused to: determine multiple dominant directions of the reference area of the prediction block; determine a ranking of the multiple dominant directions of the preference area of the prediction block, based on a respective amount of dominance determined for the respective multiple dominant directions of the reference area of the prediction block; wherein the boundary pixel of the prediction block is adjusted based on the ranking of the multiple dominant directions of the preference area of the prediction block.

19. The apparatus of claim 1, wherein the apparatus is further caused to: receive a coding of an image, video, or scene; and reconstruct the image, video, or scene, based on the smoothing of the boundary of the prediction block along the at least one dominant direction of the reference area of the prediction block.

20. A method comprising: analyzing a reference area of a prediction block to determine at least one dominant direction of the reference area of the prediction block; and adjusting a pixel value of a boundary pixel of the prediction block along the at least one dominant direction of the reference area of the prediction block.
